(19) United States
(12) Patent Application Publication
(10) Pub. No.: US 2015/0365035 A1
(43) Pub. Date: Dec. 17, 2015

(54) APPARATUS FOR DRIVING SWITCHED RELUCTANCE MOTOR AND METHOD OF CONTROLLING THE APPARATUS

(71) Applicant: Samsung Electro-Mechanics Co. Ltd., Suwon-Si (KR)

(72) Inventors: Hyung Joon KIM, Suwon-Si (KR); Hong Chul SHIN, Suwon-Si (KR); Geun Hong LEE, Suwon-Si (KR)

(73) Assignee: Samsung Electro-Mechanics Co. Ltd., Suwon-Si (KR)

(21) Appl. No.: 14/699,030

(22) Filed: Apr. 29, 2015

(30) Foreign Application Priority Data
Jun. 16, 2014 (KR) 10-2014-0072960
Aug. 11, 2014 (KR) 10-2014-0103913

(51) Int. Cl. H02P 25/08

(52) U.S. Cl. CPC H02P 25/085

(57) ABSTRACT

There is provided an apparatus for driving a switched reluctance motor (SRM) including: a converter for applying a direct current (DC) voltage supplied from a power supply unit to each phase coil of the SRM via a switching operation; and a processor for controlling a switching operation of the converter based on a driving state of the SRM.

### CROSS-REFERENCE TO RELATED APPLICATION

This application claims the benefit of Korean Patent Application No. 10-2014-0072960, filed on Jun. 16, 2014, entitled “Apparatus for Driving SRM and Controlling Method Thereof” and Korean Patent Application No. 10-2014-0103913, filed on Aug. 11, 2014, entitled “Apparatus for Driving SRM and Controlling Method Thereof” which are hereby incorporated by reference in their entireties into this application.

### BACKGROUND

The present disclosure relates to an apparatus for driving a switched reluctance motor (SRM) and a method of controlling the apparatus.

A SRM is a motor, to which a switching controlling device is coupled, and includes a stator and a rotor which both have a salient pole structure.

In particular, coils are wound only around the stator, and no coil or permanent magnet of any type is present at all in the rotor, and thus, the SRM has a simple structure.

Due to the structural characteristics, the SRM has considerable advantages in terms of production, and has excellent starting characteristics like a direct current (DC) motor and a great torque, but does not require much maintenance and repair, and also has excellent characteristics in terms of a torque per a unit volume, efficiency, and a rating of a converter, or the like. Thus, the application field of the SRM is gradually increasing.

The SRM as described above has various shapes such as a single-phase, a two-phase, or a three-phase structure, and a two-phase SRM particularly has a simpler driving circuit than a three-phase SRM, and is thus drawing great attention in application fields such as fans, blowers, or compressors.

Also, in a switching device of the two-phase SRM, various methods to control a current of a stator coil to be flown in a single direction have been suggested. An example of the methods is use of a switching device using an asymmetrical bridge converter for driving a conventional alternating current (AC) motor.

Furthermore, the asymmetrical bridge converter has most excellent diversity in regard to control, from among converters for driving a SRM, and a current control of each phase is independent so that currents of two phases may be overlapped, and thus are appropriate for a high voltage and a large capacity, and a rated voltage of a switch thereof is relatively low.

### RELATED ART DOCUMENT

### Patent Document

(Patent Document 1) JP 10-271885

### SUMMARY

An aspect of the present disclosure may provide an apparatus for driving a switched reluctance motor (SRM), in which, if a high current flows to a converter applying a current to each coil of the SRM, power loss in elements of the converter may be reduced.

According to an aspect of the present disclosure, an apparatus for driving a SRM may include a synchronization rectification switch that uses a synchronization rectification method in a current circulation module of a converter so as to efficiently reduce conduction loss (power loss) if a phase current flowing to each phase coil of the SRM is high.

That is, the apparatus for driving a SRM according to the present disclosure may include a converter for applying a direct current (DC) voltage supplied from a power supply unit via a switching operation and a processor for controlling the switching operation of the converter.

Also, the converter may include: a switching module for applying the DC voltage to each phase coil of the SRM via the switching operation; and a current circulation module for circulating a current flowing to each phase coil of the SRM in a predetermined direction, via the switching operation.

Further, the current circulation module may include a diode and a synchronization rectification switch that are cross-connected to an end of each phase coil of the SRM. One end of the synchronization rectification switch may be connected to a contact point between one phase coil of the SRM and a fourth switch, and the other end of the synchronization rectification switch may be connected to a contact point between the other phase coil of the SRM and a first switch. The synchronization rectification switch may be a metal oxide semiconductor field effect transistor (MOSFET).

Also, the processor may control the synchronization rectification switch such that an operating timing of the synchronization rectification switch is synchronized with an operating timing of the third switch and an operating timing of the fourth switch, and may be formed of a controller and a pulse width modulation (PWM) signal generating module.

In detail, the controller may generate a control signal used to synchronize a turn-on timing of the synchronization rectification switch with a turn-on timing of the fourth switch and synchronize a turn off timing of the synchronization rectification switch with a turn-on timing of the third switch.

Also, the PWM signal generating module may generate a PWM signal for controlling turn on and turn off operations of the synchronization rectification switch based on the control signal of the controller to apply the PWM signal to the synchronization rectification switch.

Accordingly, the apparatus for driving the SRM according to an exemplary embodiment of the present disclosure may efficiently reduce conduction loss (power loss) due to a second diode D₂ according to the related art by using the synchronization rectification switch S_{SYNC} based on the synchronization rectification method (about 80% or more may be reduced), and accordingly, the total power efficiency of the entire circuit may be improved, and durability may be provided due to reduction in heat generation.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a block diagram illustrating an apparatus for driving a switched reluctance motor (SRM) according to an exemplary embodiment of the present disclosure;

FIG. 2A is a circuit diagram of a converter according to the related art, and FIG. 2B illustrates an operating order of switches included in the converter at each phase of a switched reluctance motor (SRM) according to the related art;

FIG. 3A is a circuit diagram of a converter according to an exemplary embodiment of the present disclosure, and FIG. 3B illustrates a degree of power loss according to amplitude of a current of the converter according to the present disclosure;

FIGS. 4A through 4J illustrate a current loop according to a switching operation of a converter according to an exemplary embodiment of the present disclosure; and

FIG. 5 shows a current and a voltage of elements of a converter at each phase of a SRM according to an exemplary embodiment of the present disclosure.

### DETAILED DESCRIPTION

The objects, features and advantages of the present disclosure will be more clearly understood from the following detailed description of the exemplary embodiments taken in conjunction with the accompanying drawings. Throughout the accompanying drawings, the same reference numerals are used to designate the same or similar components, and redundant descriptions thereof are omitted. Further, in the following description, the terms “first,” “second,” “one side,” “the other side” and the like are used to differentiate a certain component from other components, but the configuration of such components should not be construed to be limited by the terms. Further, in the description of the present disclosure, when it is determined that the detailed description of the related art would obscure the gist of the present disclosure, the description thereof will be omitted.

Hereinafter, exemplary embodiments of the present disclosure will be described in detail with reference to the accompanying drawings.

Hereinafter, an apparatus for driving a motor and a method of controlling the apparatus according to an exemplary embodiment will be described in detail, and the motor refers to a two-phase switched reluctance motor (SRM). Here, description will focus on a two-phase (phases A and B) SRM, but a SRM may also have coils of two or more phases.

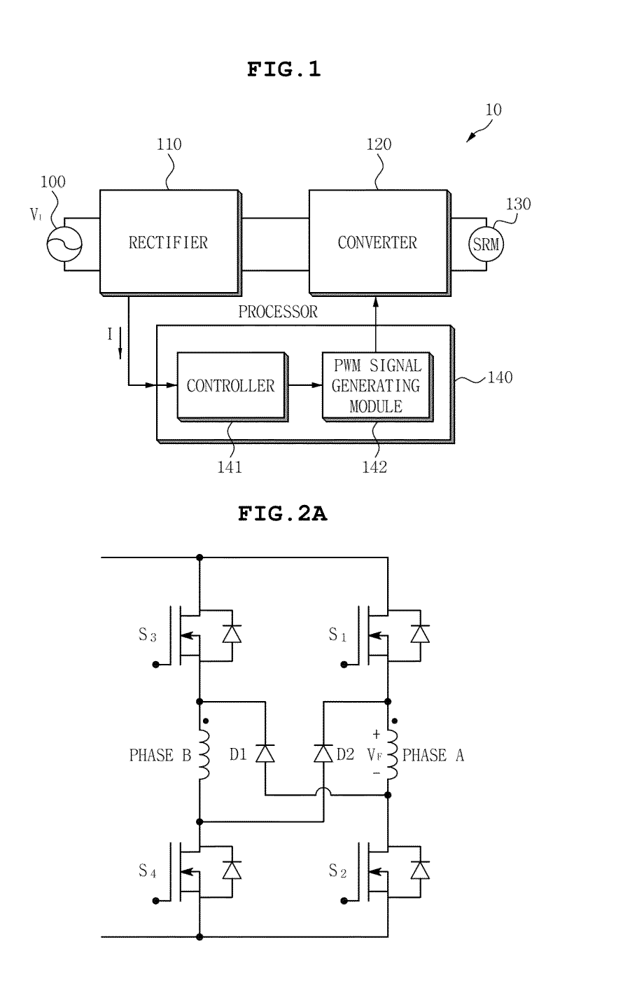

FIG. 1 is a block diagram illustrating an apparatus for driving an SRM according to an exemplary embodiment of the present disclosure, which may include a rectifier 110, a converter 120, and a processor 140.

The rectifier 110 may rectify a common voltage VI (AC) of a power supply unit 100 to generate a direct current (DC) voltage, and may include a smoothing capacitor (not shown) smoothing the common voltage V_{I} (improving a power factor of a DC voltage and absorbing noise) and a bridge rectifier circuit (not shown) rectifying the smoothed common voltage V_{I}.

The converter 120 applies the DC voltage to each phase of an SRM 130 by a switching operation, and includes a switching module (S1 through S4) applying the DC voltage to each phase coil of the SRM 130 by the switching operation and a current circulation module (S_{SYNC}, D) circulating a current flowing through each phase coil of the SRM 130 in a predetermined direction during the switching operation.

The switching module (S1 through S4) includes a first switch S1 serially connected to an upper portion of one phase coil of the SRM 130, a second switch S2 serially connected to a lower portion of the one phase coil of the SRM 130, a third switch S3 serially connected to an upper portion of the other phase coil of the SRM 130, and a fourth switch S4 serially connected to a lower portion of the other phase coil of the SRM 130.

The current circulation module (S_{SYNC},D) includes a diode D and a synchronization rectification switch S_{SYNC} that are cross-connected to two ends of two phase coils (coil of phase A and coil of phase B), and a positive electrode of the diode D is connected to a contact point between one phase coil of the SRM 130 (coil of phase A) and the first switch S1, and a negative electrode of the diode D is connected to a contact point between the other phase coil of the SRM 130 (coil of phase B) and the third switch S3.

Also, one end of the synchronization rectification switch S_{SYNC} is connected to a contact point between the one phase coil (coil of phase A) of the SRM 130 and the fourth switch S4, and the other end of the synchronization rectification switch S_{SYNC} is connected to a contact point between the other phase coil (coil of phase B) of the SRM 130 and the first switch S1. Here, the synchronization rectification switch S_{SYNC} may be a metal-oxide semiconductor field effect transistor (MOSFET), but is not limited thereto.

The processor 140 controls a switching operation of the converter 120 based on a driving state of the SRM 130 (a position and a speed of a rotor (not shown)). That is, the processor 140 may control a switching operation of the switching module (S1 through S4) and the current circulation module (S_{SYNC},D) of the converter 120 based on a driving state of the SRM 130 so that the DC voltage is sequentially applied to each phase coil of the SRM 130.

Here, the processor 140 may be a microcontroller unit (MCU), and includes a pulse width modulation (PWM) signal generating module 142 generating a PWM signal to be applied to the first and second and upper and lower switches (S1 through S4) of the converter 120 and a controller 141 generating a control signal used to control the PWM signal generating module 142.

Furthermore, the processor 140 controls the synchronization rectification switch S_{SYNC} such that an operating timing of the synchronization rectification switch S_{SYNC} is synchronized with an operating timing of the switching module (S1 through S4). That is, the processor 140 controls the synchronization rectification switch S_{SYNC} such that an operating timing of the synchronization rectification switch S_{SYNC} is synchronized with operating timings of the third switch S3 and the fourth switch S4.

In more detail, the controller 141 generates a control signal used to synchronize a turn-on timing of the synchronization rectification switch S_{SYNC} with a turn-on timing of the fourth switch S4, and a turn off timing of the synchronization rectification switch S_{SYNC} with a turn-on timing of the third switch S3.

Also, the PWM signal generating module 142 generates a PWM signal used to control turn-on and turn-off operations of the synchronization rectification switch S_{SYNC} based on a control signal of the controller 141 and applies the PWM signal to the synchronization rectification switch S_{SYNC}.

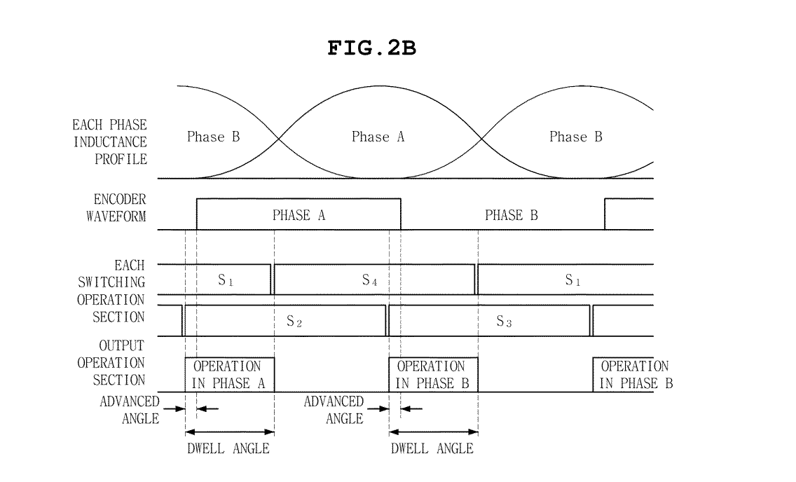

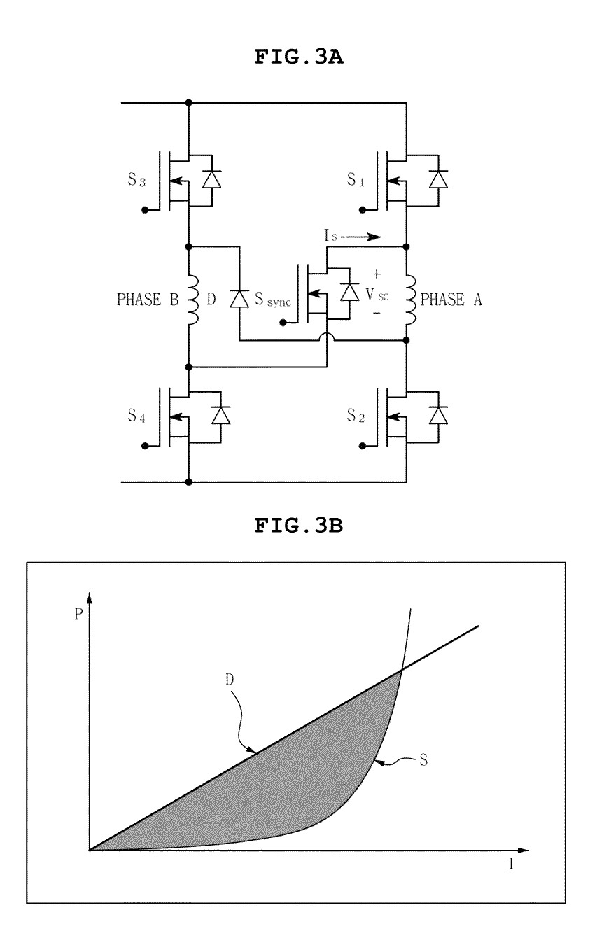

Hereinafter, a converter of a SRM according to the present disclosure will be described in detail with reference to FIGS. 2A through 3B.

FIG. 2A is a circuit diagram of a converter according to the related art, and FIG. 2B illustrates an operating order of switches included in the converter at each phase of a switched reluctance motor (SRM) according to the related art.

Also, FIG. 3A is a circuit diagram illustrating a converter according to an exemplary embodiment of the present disclosure, and FIG. 3B illustrates a degree of power loss according to amplitude of a current of the converter according to the present disclosure.

As illustrated in FIG. 2A, the converter 120 of the SRM according to the related art includes a pair of switches that are vertically serially connected to each of two phase coils (not shown) of the two-phase SRM 130, and a first diode D1 and a second diode D2 that are cross-connected to the both ends of the two phase coils.

Also, as illustrated in FIG. 2B, in the converter 120 of the SRM according to the related art, the first switch S1 and the fourth switch S4 and the second switch S2 and the third switch S3 may be turned on while maintaining a phase difference of 180° with respect to each other, and an advance angle may be adjusted by controlling a ON point of the second switch S2 and the third switch S3 with respect to an encoder wave, and a dwell angle may be adjusted by controlling an ON point of the first switch S1 and the fourth switch S4 with respect to the encoder wave.

However, in the converter 120 of the SRM according to the related art, when a switching operation of the first through fourth switches S1 through S4 is performed, power loss in the switching operation may be reduced by using a zero voltage switching (ZVS) method, but if a current I_{F} flowing to the second diode D2 is large, power loss P_{LOSS(DIODE)} due to the second diode D2 is increased as expressed in [Equation 1] below, and thus the total power efficiency of the converter 120 is decreased and heat is generated. Here, VF denotes a forward voltage drop of the second diode D2 and may be determined based on diode characteristics (for example, VF=1[v]).

P_{LOSS(DIODE)}=V_{F}×I_{F} [Equation 1]

For example, if amplitude of a current flowing to the second diode D2 is 8 [A], and VF is 1[v], power loss P_{LOSS(DIODE)} due to the second diode D2 is 8 [W].

As illustrated in FIG. 3A, the converter 120 according to an exemplary embodiment of the present disclosure includes the first switch S1 and the second switch S2 that are vertically serially connected to a coil of phase A, and the third switch S3 and the fourth switch S4 that are vertically serially connected to a coil of phase B, the first diode D1 and the second diode D2 that are cross-connected to two ends of the coils of the two phases, and the synchronization rectification switch S_{SYNC}, and a method of driving the converter 120 will be described in more detail later.

Accordingly, by using a synchronous rectification method by using the synchronization rectification switch S_{SYNC} instead of the second diode D2, the converter 120 may secure the total power efficiency thereof and prevent malfunction thereof due to heat generation.

The power loss P_{LOSS(SYNC)} in the synchronization rectification switch S_{SYNC} according to the synchronous rectification method may be expressed as in [Equation 2] below.

P_{LOSS(SYNC)}=I_{S}²×R_{ds(on)} [Equation 2]

Here, R_{ds} denotes internal resistance between a drain (d) and a source (s) of a MOSFET, and I_{S} denotes a current flowing to the synchronization rectification switch S_{SYNC}.

For example, if a current I_{S} flowing to the synchronization rectification switch S_{SYNC} is 8 [A], and R_{ds} is 10 [mΩ], the power loss P_{LOSS(SYNC)} is 0.64 [W] in the synchronization rectification switch S_{SYNC}.

That is, as illustrated in FIG. 3B, in the converter 120 of the SRM according to the related art, power loss due to the second diode D2 increases in proportion to amplitude of a current I_{F} flowing to the second diode D2 (graph D).

However, as expressed in [Equation 2], power loss due to the synchronization rectification switch S_{SYNC} does not increase in proportion to amplitude of a current flowing to the synchronization rectification switch S_{SYNC} (graph S).

Accordingly, the apparatus for driving the SRM 130 according to an exemplary embodiment of the present disclosure may efficiently reduce conduction loss (power loss) due to the second diode D2 according to the related art by using the synchronization rectification switch S_{SYNC} based on the synchronization rectification method (about 80% or more may be reduced), and accordingly, the total power efficiency of the entire circuit may be improved, and durability may be provided due to reduction in heat generation.

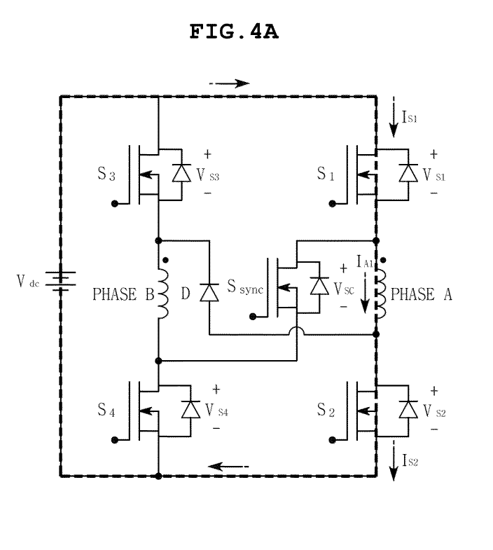

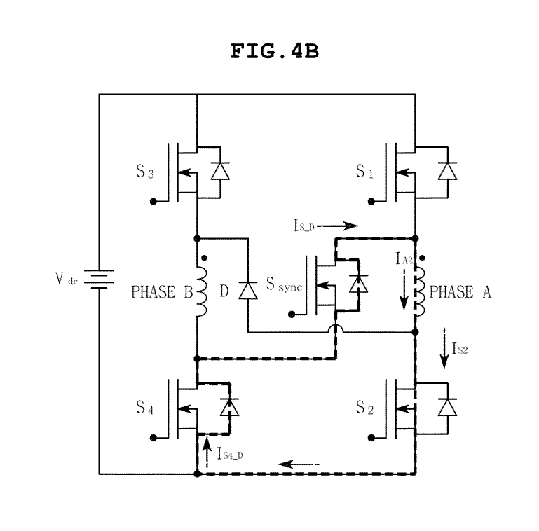

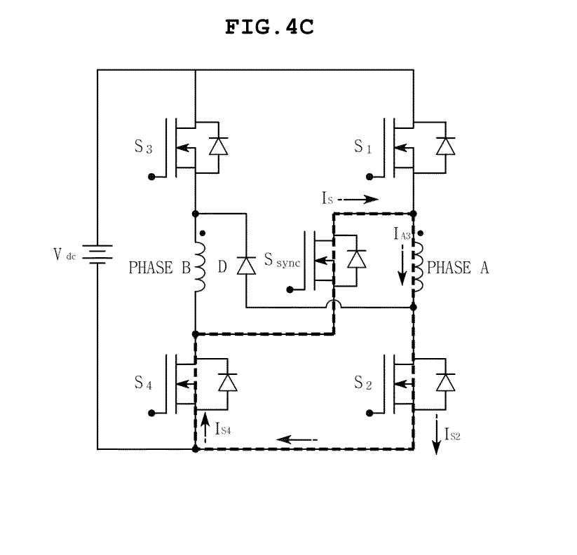

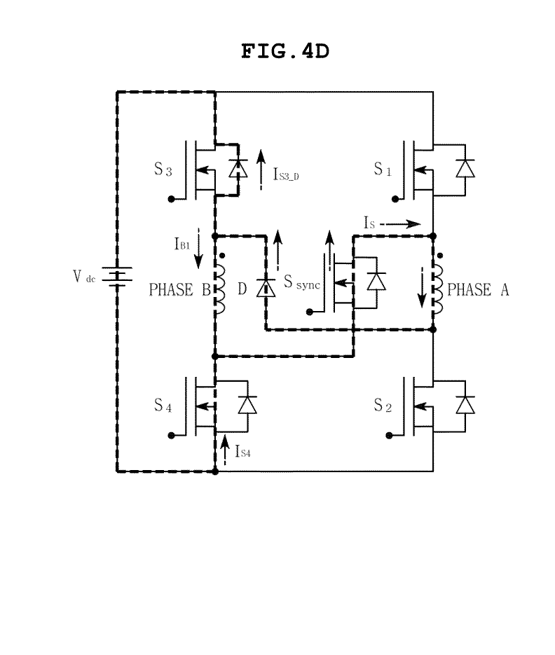

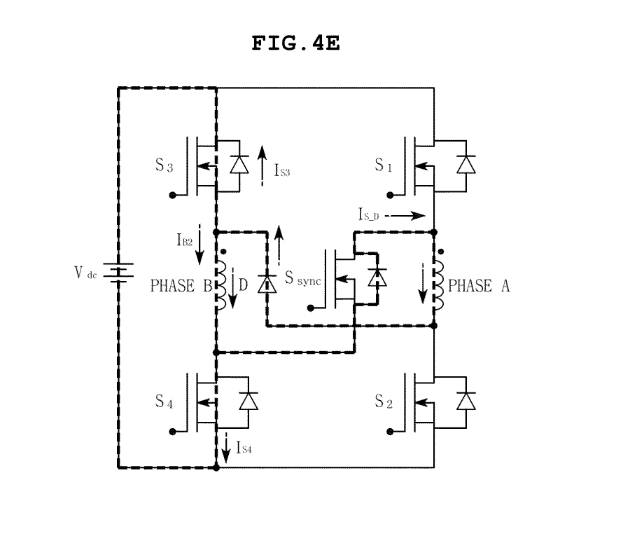

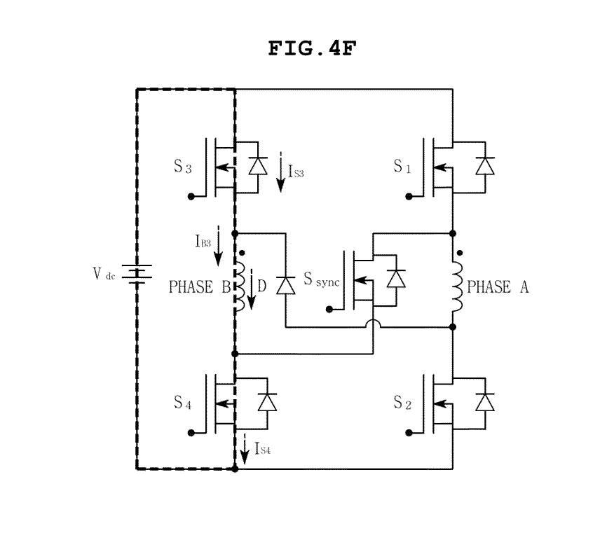

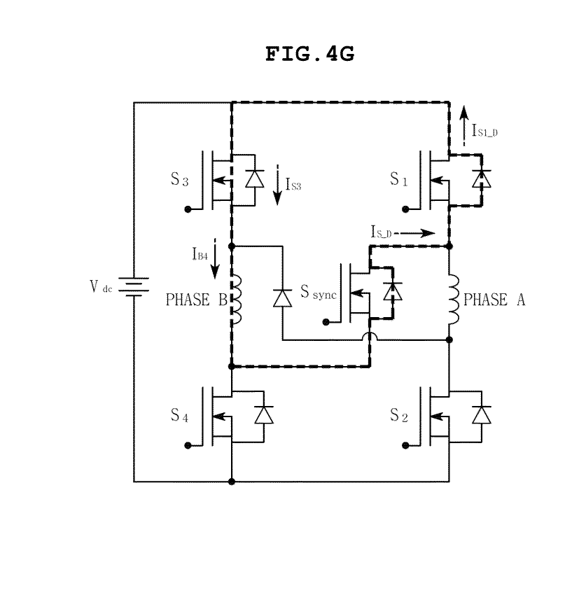

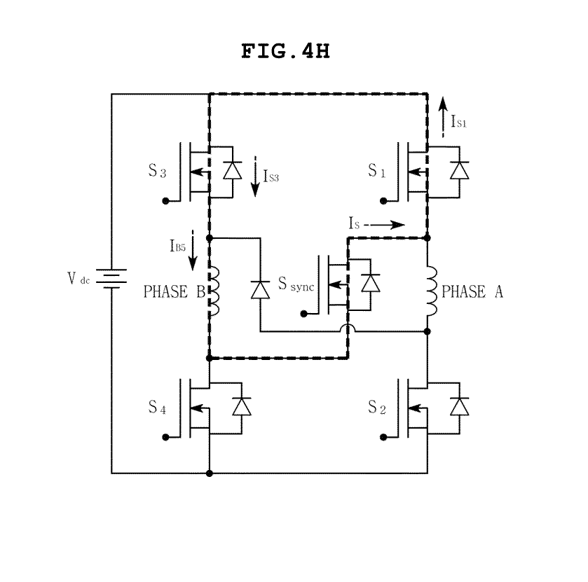

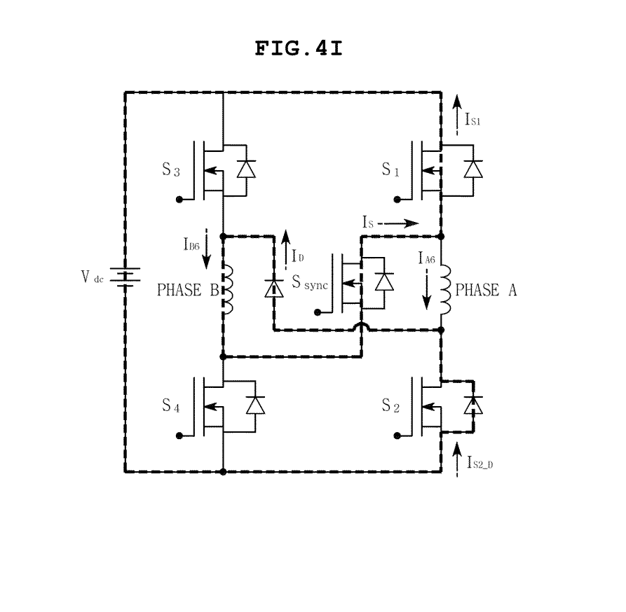

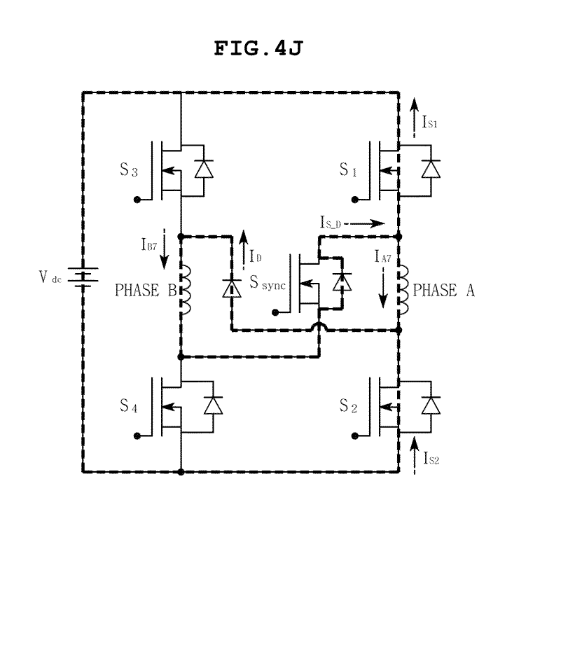

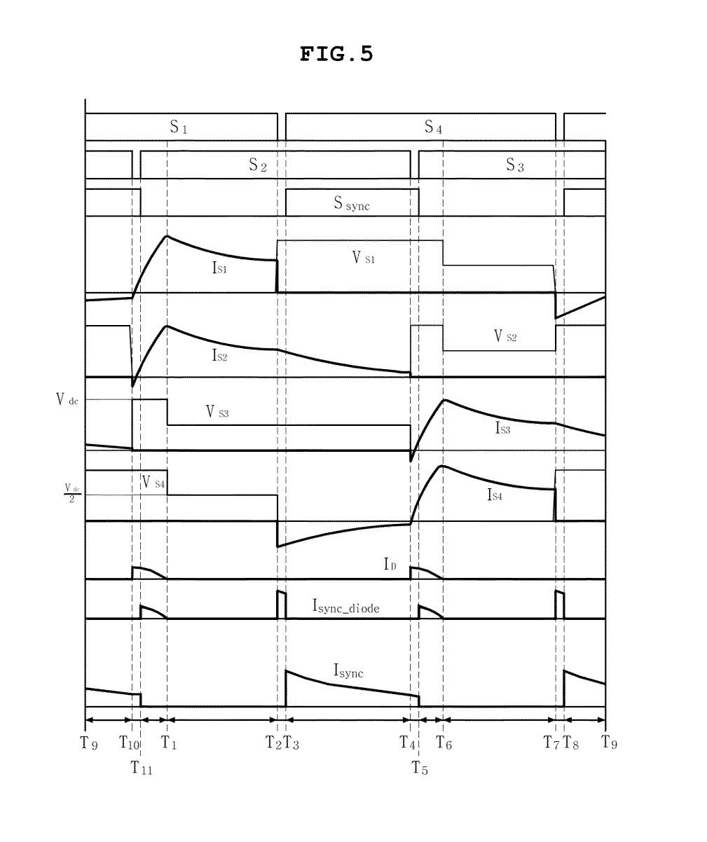

Hereinafter, a method of controlling the apparatus for driving the SRM according to an exemplary embodiment of the present disclosure will be described in detail with reference to FIGS. 4A through 4J and 5.

FIGS. 4A through 4J illustrate a current loop according to a switching operation of a converter according to an exemplary embodiment of the present disclosure. FIG. 5 shows a current and a voltage of elements of the converter at each phase of the SRM according to an exemplary embodiment of the present disclosure.

The method of controlling a SRM according to an exemplary embodiment of the present disclosure includes a driving operation in which a DC voltage supplied from the power supply unit 100 is applied to one phase coil of the SRM 130 via a switching operation, and a phase converting operation in which the switching operation is controlled to sequentially apply the DC voltage to the other phase coil of the SRM 130.

(1) The driving operation includes 1) an energy transferring operation in which a voltage is applied to one phase coil of the SRM 130 and 2) a first circulation current operation in which a phase current flowing to the phase coil is circulated in a predetermined direction.

\textcircled{1} The energy transferring operation includes an operation of turning on the first switch S1 that is serially connected to the upper portion of the one phase coil and an operation of turning on the second switch S2 that is serially connected to the lower portion of the one phase coil of the SRM 130.

In detail, as illustrated in FIG. 4A, according to a control signal of the processor 140, the first switch S1 and the second switch S2 of the converter 120 are each turned on in the energy transfer operation (first section (T1-T2)(see FIG. 5)).

Also, as a DC voltage V_{dc} is applied to a coil of phase A via the switching, a circulation current I_{A1} flows to the first switch S1, the coil of phase A, and the second switch S2.

Here, a current I_{S1} and a current I_{S2} may have the same current amplitude with the current I_{A1} and the current I_{S1} and the current I_{S2} may gradually decrease due to a speed electromotive force

$$( i \cdot \frac{d {L}_{motor}}{d θ} \cdot ω )$$

induced in the coil of phase A.

Here, a voltage V_{dc} of 2[V] is applied as each of a synchronization rectification switch voltage V_{SYNC} and a voltage V_{S4} of the fourth switch S4, and also, a voltage V_{dc} of 2[V] is maintained as a voltage V_{S3} of the third switch S3 and at the diode D.

\textcircled{2} The first circulation current operation(T1˜T5)(see FIG. 5) includes i) a 1-1 circulation current operation in which the first switch S1 is turned off and the turn-on state of the second switch S2 is maintained, ii) a 1-2 circulation current operation in which the turn-on state of the second switch S2 is maintained and the fourth switch S4 that is serially connected to the lower portion of the other phase coil of the SRM is turned on, and iii) a 1-3 circulation current operation in which the second switch S2 is turned off and the turn-on state of the fourth switch S4 is maintained.

Here, in the 1-2 circulation current operation (ii), a turn-on timing of the synchronization rectification switch S_{SYNC} is synchronized with a turn-on timing of the fourth switch S4. Also, in the 1-3 circulation current operation (iii), a turn-off timing of the synchronization rectification switch S_{SYNC} is synchronized with a turn-on timing of the third switch S3.

That is, as illustrated in FIG. 4B, in the 1-1 circulation current operation (second section (T2-T3)(see FIG. 5)), the first switch S1 of the converter 120 is turned off and the second switch S2 of the converter 120 maintains an ON state according to a control signal of the processor 140.

Here, the fourth switch voltage V_{S4} and the synchronization rectification switch voltage V_{SYNC} converge to 0 [V], and thus, a driving voltage Vdc is applied as a first switch voltage V_{S1}.

Here, a circulation current I_{S}_{_{—}}_{D} flows through a current loop formed of the coil of phase A, the second switch S2, an internal diode of the fourth switch S4, and an internal diode of the synchronization rectification switch S_{SYNC}, in an order, and the current I_{S}_{_{—}}_{D}, the current I_{S2}, and a current I_{S4}_{_{—}}_{D} have the same amplitude and the same direction.

Next, as illustrated in FIG. 4C, in the 1-2 circulation current operation (third section (T3-T4)(see FIG. 5)), the turn-on state of the second switch S2 of the converter 120 is maintained and the fourth switch S4 is turned on according to a control signal of the processor 140.

Here, the synchronization rectification switch S_{SYNC} may be synchronized with a turn-on timing of the fourth switch S4 to be turned on, and the DC voltage V_{dc} is maintained at the first switch S1.

Here, the circulation current I_{S} flows through a current loop formed of the coil of phase A, the second switch S2, the fourth switch S4, and the synchronization rectification switch S_{SYNC}, in an order. Here, the current I_{S}, the current I_{S2}, and a current I_{S4} have the same amplitude and the same direction.

Also, a speed electromotive force of the circulation currents I_{S}, I_{S2}, and I_{S4} flowing to the coil of phase A increases according to a rotational speed of the SRM with time, according to [Equation 3] below, and accordingly, an inclination of a variation in the circulation currents is reduced, and thus the circulation currents are gradually decreased.

$${V}_{d c} = {L}_{motor} \cdot \frac{d i}{d t} + i \cdot \frac{d {L}_{motor}}{d θ} \cdot ω \qquad [ Equation 3 ]$$

(I=the current of each phase, L=Inductance of each phase, W=angular velocity)

Here, in the second section (T2-T3)(see FIG. 5), the fourth switch voltage V_{S4} of the fourth switch S4 converge to 0 [V] via the internal diode of the fourth switch S4 in a process in which the circulation current I_{S4}_{_{—}}_{D} flows, and then the fourth switch S4 is turned on.

Accordingly, before the fourth switch voltage V_{S4} converges to 0 [V], the fourth switch S4 is turned on so that zero voltage switching (ZVS) whereby power loss (switching loss) that may be caused in a switching process between the fourth switch voltage V_{S4} and the fourth switch current I_{S4} may be prevented may be performed.

Also, as illustrated in FIG. 4D, in a 1-3 circulation current operation (fourth section (T4-T5)(see FIG. 5)), the second switch S2 of the converter 120 is turned off and an ON state of the fourth switch S4 is maintained according to a control signal of the processor 140.

Here, an ON state of the synchronization rectification switch S_{SYNC} is maintained, and the DC voltage V_{dc} is maintained at the first switch S1.

Also, a current loop formed of the fourth switch S4, the synchronization rectification switch S_{SYNC}, the coil of phase A, the diode D, and an internal diode of the third switch S3, in an order, is formed, and the circulation current I_{S} flows through the current loop. Here, I_{S}=I_{S3}_{_{—}}_{D}+I_{B1} or I_{S}=I_{S4}+I_{B1}

Here, as a negative voltage (−V_{dc}) is applied to the coil of phase A, the circulation current I_{S} flowing to the coil of phase A is gradually reduced, and the driving voltage V_{dc} is applied to the coil of phase B, and thus amplitude of a current I_{B1} is gradually increased, but the current I_{B1} is smaller than the circulation current I_{S} flowing to the coil of phase A.

(2) The above phase converting operation includes 1) an energy converting operation in which the switching operation is controlled to apply a voltage to the other phase coil of the SRM and 2) a second circulation current operation in which a phase current flowing to the phase coil is circulated in a predetermined direction.

\textcircled{1} The energy converting operation includes an operation of turning on the third switch S3 that is serially connected to the upper portion of the other phase coil and an operation of turning off the fourth switch S4 that is serially connected to the lower portion of the other phase coil.

That is, as illustrated in FIG. 4E, in the energy converting operation (fifth section (T5-T6) (see FIG. 5)), according to a control signal of the processor 140, the ON state of the fourth switch S4 of the converter 120 is maintained, and the third switch S3 of the converter 120 is turned on.

Here, a turn-off timing of the synchronization rectification switch S_{SYNC} is synchronized with a timing when the third switch S3 is turned on, and a DC voltage Vdc is applied to the first switch S1.

Here, a current loop formed of an internal diode of the synchronization rectification switch S_{SYNC}, the coil of phase A, and the diode D and the coil of phase B in an order, and a current loop formed of the third switch S3 and the fourth switch S4, in an order, are formed.

Also, a current I_{S3} or I_{S4} corresponding to a current difference between a current I_{B2} flowing to the coil of phase B and a current flowing to the coil of phase A flows to the third switch S3 and the fourth switch S4, and a circulation current I_{S-D} flowing to the coil of phase A is gradually decreased to be smaller than amplitude of the current I_{B2} flowing to the coil of phase B.

Next, as illustrated in FIG. 4F, in a sixth section (T6-T7) (see FIG. 5), an ON state of the fourth switch S4 and the third switch S3 is maintained, and a current loop formed of the third switch S3, the coil of phase B, and the fourth switch S4 is formed.

Accordingly, a circulation current I_{B3} flows to the current loop, and the currents I_{S3}, I_{B3}, and I_{S4} have the same current amplitude, and the current I_{B3} may gradually decrease due to a speed electromotive force.

Here, the synchronization rectification switch voltage V_{SYNC} and the voltage V_{S4} of the fourth switch S4 may be each a voltage V_{dc} of 2[V], and a voltage V_{dc} of 2[V] is maintained as the third switching voltage V_{S3} and at the diode D.

\textcircled{2} The second circulation current operation includes i) a 2-1 circulation current operation in which the fourth switch S4 is turned off and the turn-on state of the third switch S3 is maintained, ii) a 2-2 circulation current operation in which the turn-on state of the third switch S3 is maintained and the first switch S1 is turned on, and iii) a 2-3 circulation current operation in which the third switch S3 is turned off and the turn-on state of the fourth switch S4 is maintained.

Here, in the 2-2 circulation current operation (ii), a turn-on timing of the synchronization rectification switch S_{SYNC} is synchronized with a turn-on timing of the first switch S1. Also, in the 2-3 circulation current operation (iii), a turn-on timing of the synchronization rectification switch S_{SYNC} is synchronized with a turn-on timing of the second switch S2.

That is, as illustrated in FIG. 4G, in the 2-1 circulation current operation (seventh section \textcircled{7} (T7-T8)(see FIG. 5)), 1) while the third switch S3 is maintained in an on state, the fourth switch S4 is turned off, and a current loop formed of the third switch S3, the coil of B phase, an internal diode of the synchronization rectification switch S_{SYNC}, and an internal diode of the first switch S1, in an order, is formed.

Here, a circulation current I_{B4} flows to the current loop, and the currents I_{S3}, the circulation current I_{B4}, and a current I_{SYNC}_{_{—}}_{D} have the same current amplitude, and the current I_{B4} is gradually decreased by a speed electromotive force.

Also, as illustrated in FIG. 4H, in the 2-2 circulation current (eighth section \textcircled{8} (T8-T10) (see FIG. 5)), an ON state of the third switch S3 is maintained, and the first switch S1 is turned on.

Here, a turn-on timing of the synchronization rectification switch S_{SYNC} is synchronized with a timing when the first switch S1 is turned on, and a voltage that is close to the driving voltage V_{dc} is applied to the fourth switch S4.

Here, a current loop in which a current flows to the third switch S3, the coil of phase B, and the synchronization rectification switch S_{SYNC}, in an order, is formed.

Next, as illustrated in FIG. 4I, in the 2-2 circulation current operation (eighth section \textcircled{9} (T10-T11) (see FIG. 5)), the ON state of the first switch S1 is maintained, and the third switch S3 is turned off and the ON state of the synchronization rectification switch S_{SYNC} is maintained.

Here, a current loop formed of the coil of phase B, the synchronization rectification switch S_{SYNC}, the coil of phase A and the diode D and a current loop formed of the first switch S1 and the internal diode of the second switch S2, in an order.

Here, a positive driving voltage (+V_{dc}) is applied to two ends of the coil of phase A so that a current flowing to the coil of phase A is gradually increased, and a negative driving voltage (+V_{dc}) is applied to two ends of the coil of phase B so that a current flowing to the coil of phase B is gradually decreased.

Also, as illustrated in FIG. 4J, in the 2-3 circulation current operation in tenth section \textcircled{10} (T11-T1) (see FIG. 5), the on state of the first switch S1 is maintained, and the second switch S2 is turned on. Here, the synchronization rectification switch S_{SYNC} is synchronized with a timing when the second switch S2 is turned on, to be thereby turned off.

Here, a current loop formed of the coil of phase B, the internal diode of the synchronization rectification switch S_{SYNC}, the coil of phase A and the diode D and a current loop formed of the first switch S1 and the second switch S2, in an order.

Subsequently, the energy transfer operation of phase A and the first circulation current operation (the first through sixth sections (T1-T7) (see FIG. 5)) described above are performed in the same manner so that the rotor (not shown) of the SRM 130 is rotated.

Although the embodiments of the present disclosure have been disclosed for illustrative purposes, it will be appreciated that the present disclosure is not limited thereto, and those skilled in the art will appreciate that various modifications, additions and substitutions are possible, without departing from the scope and spirit of the disclosure.

Accordingly, any and all modifications, variations or equivalent arrangements should be considered to be within the scope of the disclosure, and the detailed scope of the disclosure will be disclosed by the accompanying claims.

What is claimed is:

1. An apparatus for driving a switched reluctance motor (SRM) comprising:
a converter for applying a direct current (DC) voltage supplied from a power supply unit to each phase coil of the SRM via a switching operation; and
a processor for controlling a switching operation of the converter based on a driving state of the SRM.

2. The apparatus for driving an SRM of claim 1, further comprising a rectifier for rectifying a common voltage (AC) supplied from the power supply unit to generate a DC voltage and applying the DC voltage to the converter.

3. The apparatus for driving an SRM of claim 1, wherein the converter includes:
a switching module for applying the DC voltage to each phase coil of the SRM via the switching operation; and
a current circulation module for circulating a current flowing to each phase coil of the SRM in a predetermined direction, during the switching operation.

4. The apparatus for driving an SRM of claim 3, wherein the current circulation module includes a diode and a synchronization rectification switch that are cross-connected to an end of each phase coil of the SRM.

5. The apparatus for driving an SRM of claim 4, wherein the switching module includes:
a first switch that is serially connected to an upper portion of one phase coil of the SRM;
a second switch that is serially connected to a lower portion of the one phase coil of the SRM;
a third switch that is serially connected to an upper portion of the other phase coil of the SRM; and
a fourth switch that is serially connected to a lower portion of the other phase coil of the SRM.

6. The apparatus for driving an SRM of claim 5, wherein a positive electrode of the diode is connected to a contact point between the one phase coil of the SRM and the first switch, and a negative electrode of the diode is connected to a contact point between the other phase coil of the SRM and the third switch, and
wherein one end of the synchronization rectification switch is connected to a contact point between the one phase coil of the SRM and the fourth switch, and the other end of the synchronization rectification switch is connected to a contact point between the other phase coil of the SRM and the first switch.

7. The apparatus for driving an SRM of claim 6, wherein the synchronization rectification switch is a metal oxide semiconductor field effect transistor (MOSFET).

8. The apparatus for driving an SRM of claim 5, wherein the processor controls the synchronization rectification switch such that an operating timing of the synchronization rectification switch is synchronized with an operating timing of the switching module.

9. The apparatus for driving an SRM of claim 8, wherein the processor controls the synchronization rectification switch such that the operating timing of the synchronization rectification switch is synchronized with operating timings of the third switch and the fourth switch.

10. The apparatus for driving an SRM of claim 9, wherein the processor includes:
a controller for controlling a switching operation of the converter based on a driving state of the SRM; and
a pulse width modulation (PWM) signal generating module for generating a PWM signal for controlling the switching operation of the converter based on a control signal received from the controller, to apply the PWM signal to the converter.

11. The apparatus for driving an SRM of claim 10, wherein the controller generates a control signal used to synchronize a turn-on timing of the synchronization rectification switch with a turn-on timing of the fourth switch and synchronize a turn off timing of the synchronization rectification switch with a turn-on timing of the third switch, and
wherein the PWM signal generating module generates a PWM signal for controlling turn on and turn off operations of the synchronization rectification switch based on the control signal of the controller to apply the PWM signal to the synchronization rectification switch.

12. A method of controlling an apparatus for driving a switched reluctance motor (SRM), the method comprising:
a driving operation in which a direct current (DC) voltage supplied from a power supply unit is applied to one phase coil of the SRM, via a switching operation; and
a phase converting operation in which the switching operation is controlled to sequentially apply the DC voltage to the other phase coil of the SRM.

13. The method of claim 12, wherein the driving operation includes:
an energy transfer operation in which a voltage is applied to the one phase coil of the SRM; and
a 1 circulation current operation in which a phase current flowing to the phase coil is circulated in a predetermined direction.

14. The method of claim 13, wherein the energy transfer operation includes:
turning on a first switch that is serially connected to an upper portion of the one phase coil; and
turning on a second switch that is serially connected to a lower portion of the one phase coil of the SRM.

15. The method of claim 14, wherein the circulation current operation includes:
a 1-1 circulation current operation in which the first switch is turned off and the turn-on state of the second switch is maintained;
a 1-2 circulation current operation in which the turn-on state of the second switch is maintained, and a fourth switch that is serially connected to a lower portion of the other one phase coil of the SRM is turned on; and
a 1-3 circulation current operation in which the second switch is turned off, and the turn-on state of the fourth switch is maintained.

16. The method of claim 15, wherein in the 1-2 circulation current operation, a turn-on timing of the synchronization rectification switch is synchronized with a turn-on timing of the fourth switch, and
in the 1-3 circulation current operation, the turn-on timing of the synchronization rectification switch is synchronized with a turn-on timing of the third switch.

17. The method of claim 15, wherein the phase converting operation includes:
an energy converting operation in which the switching operation is controlled to apply a voltage to the other phase coil of the SRM; and
a 2 circulation current operation in which a phase current flowing to the phase coil is circulated in a predetermined direction.

18. The method of claim 17, wherein the energy converting operation includes:
turning on the third switch that is serially connected to the upper portion of the other phase coil; and
turning on the fourth switch that is serially connected to the lower portion of the other phase coil.

19. The method of claim 18, wherein the 2 circulation current operation includes:
a 2-1 circulation current operation in which the fourth switch is turned off and the turn-on state of the third switch is maintained;
a 2-2 circulation current operation in which the turn-on state of the third switch is maintained, and the first switch is turned on; and
a 2-3 circulation current operation in which the third switch is turned off, and the turn-on state of the fourth switch is maintained.

20. The method of claim 19, wherein in the 2-2 circulation current operation, a turn-on timing of the synchronization rectification switch is synchronized with a turn-on tuning of the first switch, and
in the 2-3 circulation current operation, the turn-off timing of the synchronization rectification switch is synchronized with a turn-on timing of the second switch.
